(19) United States
(12) Patent Application Publication
(10) Pub. No.: US 2022/0221981 A1
(43) Pub. Date: Jul. 14, 2022

(54) APPARATUS AND METHOD FOR ADAPTATION OF PERSONALIZED INTERFACE

(71) Applicant: ELECTRONICS AND TELECOMMUNICATIONS RESEARCH INSTITUTE, Daejeon (KR)

(72) Inventors: Yongho LEE, Daejeon (KR); Wookho SON, Daejeon (KR); Beom Ryeol LEE, Daejeon (KR)

(21) Appl. No.: 17/500,351

(22) Filed: Oct. 13, 2021

(30) Foreign Application Priority Data
Jan. 12, 2021 (KR) 10-2021-0003814

(51) Int. Cl. G06F 3/0484; G06F 3/01; G02B 27/00; G02B 27/01; G06N 20/00

(52) U.S. Cl. CPC G06F 3/04842; G06F 3/013; G02B 27/0093; G02B 2027/014; G06N 20/00; G06F 3/04847; G02B 27/017

(57) ABSTRACT

A computing device adapts an interface for extended reality. The computing device collects user information and external environment information when a user loads a virtual interface to experience extended reality content, and selects a highest interaction accuracy from among one or more interaction accuracies mapped to the collected user information and external environment information. The computing device determines content information mapped to the highest interaction accuracy, and reloads the virtual interface based on a state of the virtual interface that is determined based on the determined content information.

### CROSS-REFERENCE TO RELATED APPLICATION

This application claims priority to and the benefit of Korean Patent Application No. 10-2021-0003814 filed in the Korean Intellectual Property Office on Jan. 12, 2021, the entire content of which is incorporated herein by reference.

### BACKGROUND

### 1. Field of the Invention

The described technology relates to an apparatus and method for adaptation of a personalized interface.

### 2. Description of Related Art

In input devices such as a keyboard, mouse, and touch panel, since a user clearly recognizes a device area and direct finger contact occurs, inputs can be very accurately performed. However, because a three-dimensional (3D) virtual interface used in augmented reality (AR) glasses content performs inputs through an action of moving a hand in the air without contact, a depth perception dissonance occurs so that accurate inputs cannot be performed.

The same problem occurs in virtual reality (VR) head mounted display (HMD) content that uses the 3D virtual interface, but there are several more problems in the AR glass environment. Unlike the VR HMD which consists of a virtual environment in which all contents have the same lighting conditions, in the AR glasses, the real world and virtual environment with different lighting conditions are mixed, resulting in a big hindrance to visual content recognition. Further, differently from the VR HMDs in which images can be directly viewed through a display, the AR glasses exhibit a lot of difference in terms of content quality that users accept because the images are viewed through glasses with projector images.

Because interactions between the AR content and the user are performed in lack of multisensory information, they are greatly affected by individual content recognition characteristics to fill the lack. The existing technologies attempt to improve the interaction problem by repeatedly performing small-scale experiments assuming specific environments or situations and then suggesting an averagely-preferred interface configuration. However, the existing technologies only suggest guidelines but do not reflect individual differences. Above all, there is a problem that the initially set interface cannot be changed so that a current level of interaction of the user cannot be reflected.

### SUMMARY

Some embodiments may provide an apparatus and method for adaptation of a personalized interface for providing a user with a virtual interface in an optimized state.

According to an embodiment, a method for adaptation of an interface for extended reality by a computing device may be provided. The method may include collecting first user information and first external environment information in response to a user loading a virtual interface to experience extended reality content, selecting a highest interaction accuracy from among one or more interaction accuracies mapped to the first user information and the first external environment information, determining first content information mapped to the highest interaction accuracy, and reloading the virtual interface based on a state of the virtual interface that is determined based on the first content information.

In some embodiments, selecting the highest interaction accuracy may include retrieving the one or more interaction accuracies mapped to the first user information and the first external environment information from a database in which a plurality of interaction accuracies and a plurality of pieces of interaction information are respectively mapped, and selecting the highest interaction accuracy from among the one or more interaction accuracies. In this case, in the plurality of pieces of interaction information, each interaction information may include second user information, second external environment information, and second content information.

In some embodiments, determining the first content information may include selecting the second content information mapped to the highest interaction accuracy from the database and determining the second content information as the first content information.

In some embodiments, the first content information may include transformation information of the virtual interface, color information of the virtual interface, or texture information of the virtual interface.

In some embodiments, the first user information may include information related to movement of the user or information related to a gaze of the user.

In some embodiments, the first external environment information may include information related to an external environment of the user.

In some embodiments, the one or more interaction accuracies may include a previously-calculated interaction accuracy.

In some embodiments, the one or more interaction accuracies may include an interaction accuracy predicted through a machine learning model.

In some embodiments, the machine learning model may be trained by using a previously-calculated interaction accuracy as a label, and user information, external environment information, and content information corresponding to the previously-calculated interaction data as training data.

According to another embodiment of the present invention, a method for adaptation of an interface for extended reality by a computing device may be provided. The method may include, in response to a user attempting an interaction with a virtual interface, storing data related to an interaction accuracy of the interaction, collecting a plurality of interaction accuracies by repeating storing the data related to the interaction accuracy, and adapting the virtual interface for the user based on the plurality of interaction accuracies.

In some embodiments, storing the data related to the interaction accuracy may include after setting the virtual interface to an object attempting the interaction, analyzing a type of the interaction in response to a collision flag until a collision cancellation flag occurs, and in response to completion of the interaction, storing data related to the interaction accuracy that is calculated based on analysis of the type of interaction.

In some embodiments, storing the data related to the interaction accuracy may further include setting the virtual interface to the object in response to a distance between a finger of the user and the virtual interface being less than or equal to a threshold.

In some embodiments, storing the data related to the interaction accuracy may further include starting measuring a processing time in response to the object being different from a previously-set object, and ending measuring the processing time in response to the completion of the interaction.

In some embodiments, storing the data related to the interaction accuracy may further include determining whether the collision flag or the collision cancellation flag occurs during a physics simulation, and analyzing the type of the interaction based on a collision result of the physics simulation.

In some embodiments, storing the data related to the interaction accuracy may further include calculating the interaction accuracy based on a total number of manipulation attempts and whether each manipulation is successful according to the analysis of the type of the interaction.

In some embodiments, the data related to the interaction accuracy may include user information, external environment information, and content information when the user attempts the interaction with the virtual interface.

In some embodiments, the method may further include training a machine learning model for predict an interaction accuracy by using the user information, the external environment information, and the content information as training data, and uses the interaction accuracy according to the user information, the external environment information and the content information as a label.

According to yet another embodiment, an interface adaptation apparatus including a memory configured to store one or more instructions and a processor configured to execute the one or more instructions may be provided. The processor, by executing the one or more instructions, may collect user information and external environment information in response to a user loading a virtual interface to experience extended reality content, select a highest interaction accuracy from among one or more interaction accuracies mapped to the collected user information and external environment information, determine content information mapped to the highest interaction accuracy, and reload the virtual interface based on a state of the virtual interface that is determined based on the determined content information.

According to some embodiments, the user may experience the extended reality content by utilizing an interface state having the best interaction accuracy.

### BRIEF DESCRIPTION OF THE DRAWINGS

FIG. 1 is a diagram showing an example of a personalized interface adaptation apparatus according to an embodiment.

FIG. 2 is a diagram for explaining an example of collection of interaction information in a personalized interface adaptation apparatus according to an embodiment.

FIG. 3 is a flowchart showing an example of a method of measuring an interaction accuracy in a personalized interface adaptation apparatus according to an embodiment.

FIG. 4 is a diagram for explaining an example of individual characteristic analysis in a personalized interface adaptation apparatus according to an embodiment of the present invention.

FIG. 5 is a diagram for explaining an example of interface recommendation in a personalized interface adaptation apparatus according to an embodiment.

FIG. 6 is a flowchart showing an example of a method for adaptation of a personalized interface according to an embodiment.

FIG. 7 is a diagram showing an example of a computing device according to an embodiment.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

As used herein, the singular forms “a”, “an” and “the” are intended to include the plural forms as well, unless the context clearly indicates otherwise.

The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

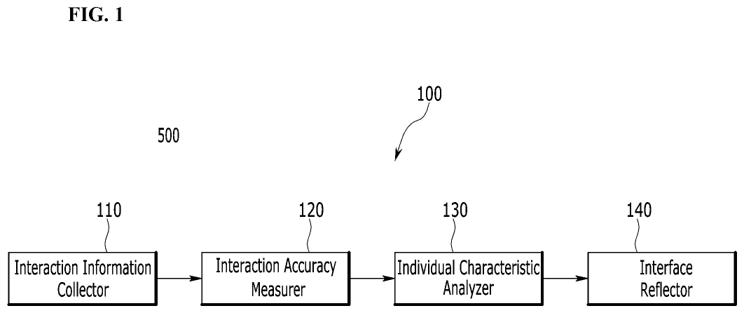

FIG. 1 is a diagram showing an example of a personalized interface adaptation apparatus according to an embodiment.

Referring to FIG. 1, an interface adaptation apparatus 100 includes an interaction information collector 110, an interaction accuracy measurer 120, an individual characteristic analyzer 130, and an interface reflector 140.

In some embodiments, an interface recommended by the interface adaptation apparatus 100 may be a virtual interface to be used to experience extended reality (XR) content. In some embodiments, the XR content may include immersive content such as virtual reality (VR) content, augmented reality (AR) content, or mixed reality (MR) content. In some embodiments, the user may experience the XR content using an XR driving device. Hereinafter, for convenience of description, the XR content is described as the AR content, and the AR driving device is described as AR glasses, but an embodiment may be applied to various XR contents and various XR driving devices.

The interaction information collector 110 continuously collects (e.g., logs) data (interaction information) affecting interactions between the AR content and a user. In some embodiments, the interaction information may include user information and content information. In some embodiments, the interaction information may further include external environment information. In some embodiments, the interaction information collector 110 may tag the collected interaction information with a collected time.

The interaction accuracy measurer 120 measures an interaction accuracy by measuring and analyzing a relationship between a user's finger movement and the virtual interface. In some embodiments, the interaction accuracy may include a type of the performed interaction, whether a manipulation is successful, and a processing time. In some embodiments, the interaction types may be classified into a specific manipulation (e.g., a manipulation such as selection, movement, rotation, or resize) on a virtual object, or a specific interface type manipulation (e.g., a manipulation such as a button, 2D panel, scroll bar, or dial).

The individual characteristic analyzer 130 calculates an expected individual interaction accuracy of a current user for a specific interaction situation based on the interaction information collected by the interaction information collector 110 and the interaction accuracy measured by the interaction accuracy measurer 120. In some embodiments, the individual characteristic analyzer 130 may calculate the expected individual interaction accuracy by building a machine learning model with the interaction information and the interaction accuracy.

The interface reflector 140, when loading (e.g., popping up) a new interface based on interaction accuracies extracted from the individual characteristic analyzer 130, may reload a final state of an interface object having the highest interaction accuracy, thereby continuously adapting an AR glass environment-based interface.

In some embodiments, the interface adaptation apparatus 100 may be implemented in a computing device. In one embodiment, the computing device 100 may be formed in the AR glasses. In another embodiment, the computing device 100 may be formed outside the AR glasses and may be connected to the AR glasses through a communication interface.

In some embodiments, the interface adaptation apparatus 100 may be implemented in a plurality of computing devices. In one embodiment, the interaction accuracy measurer 120 may be implemented in a separate computing device. In another embodiment, the individual characteristic analyzer 130 may be implemented in a separate computing device. In yet another embodiment, a function for learning the machine learning model in the individual characteristics analyzer 130 may be implemented in a separate computing device.

In some embodiments, the interaction information and the interaction accuracy according to the interaction information may be mapped and stored in a database.

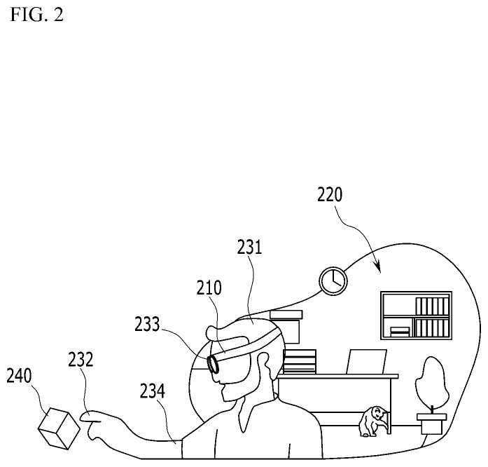

FIG. 2 is a diagram for explaining an example of collection of interaction information in a personalized interface adaptation apparatus according to an embodiment.

As shown in FIG. 2, a user may wear AR glasses 210 and experience AR content through a virtual interface. An interface adaptation apparatus (e.g., an interaction information collector 110 in FIG. 1) may collect external environment information, user information, or content information.

The interface adaptation apparatus may collect the external environment information related to an external environment of a user. In some embodiments, the interface adaptation apparatus may collect an AR glasses front camera image captured by a camera of the AR glasses 210 as the external environment information 220. In some embodiments, the interface adaptation apparatus may collect lighting data around the AR glasses 210 detected by a lighting monitoring sensor of the AR glasses 210 as external environment information 220. In some embodiments, the interface adaptation apparatus may collect distance data detected by a distance detection sensor of the AR glasses 210 as the external environment information 220.

Further, the interface adaptation apparatus may collect user information related to the user. In some embodiments, the interface adaptation apparatus may collect information related to movement of the user wearing the AR glasses 210 as the user information. In one embodiment, the movement-related information may include information about movement 231 of the user's head or information about movement 232 of the user's finger. In another embodiment, the movement-related information may further include information about a length 234 of the user's arm or information about the user's primary hand. In some embodiments, the interface adaptation apparatus may collect data related to a gaze of the user wearing the AR glasses 210 as user information. In one embodiment, the gaze-related data may include gaze tracking data 233.

Furthermore, the interface adaptation apparatus may collect content information 240 related to AR content that the user experiences with the AR glasses 210. In some embodiments, the interface adaptation apparatus may collect transformation information of a virtual object (i.e., virtual interface) as the content information 240. In some embodiments, the interface adaptation apparatus may collect color information or texture information of the AR content as the content information 240. In some embodiments, the virtual object transformation information, color information, or texture information may indicate a state of the virtual interface. In some embodiments, the interface adaptation apparatus may collect physics simulation-based collision detection data as the content information.

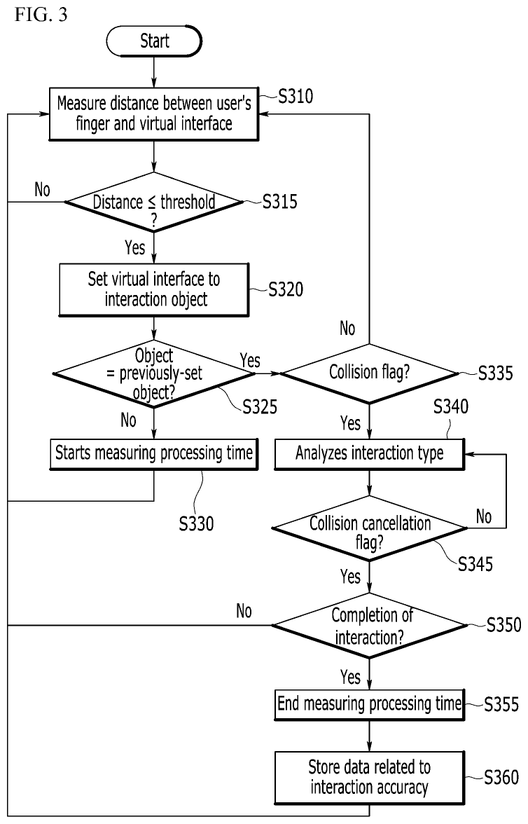

FIG. 3 is a flowchart showing an example of a method of measuring an interaction accuracy in a personalized interface adaptation apparatus according to an embodiment.

Referring to FIG. 3, at step S310, an interface adaptation apparatus (e.g., an interaction accuracy measurer 120 in FIG. 1) measures a distance between a user's finger and a virtual interface while detecting whether the user's finger approaches the virtual interface. In some embodiments, the interface adaptation apparatus may measure the distance between the user's finger and the virtual interface based on distance data of external environment information. When the distance between the user's finger and the virtual interface is less than or equal to a threshold at step S315, the interface adaptation apparatus detects that the user's finger approaches the virtual interface within a distance corresponding to the threshold, and sets the virtual interface to an object attempting an interaction at step S320. The interface adaptation apparatus determines whether the set object is the same as the object set in a previous measurement at step S325. In some embodiments, it may be determined that the set object is the same as the object set in the previous measurement when the set virtual interface and its state are the same as the virtual interface and its state set in the previous measurement. In some embodiments, when transformation of the object (virtual interface), color change of the object, or texture change of the object occurs, it may be determined that the state of the object has changed.

When the set object is not the same object as the object set in the previous measurement, the interface adaptation apparatus starts measuring a processing time of the set object from a corresponding point in time (for example, a point in time when the distance between the user's finger and the virtual interface becomes less than the threshold) at step S330. The interface adaptation apparatus starts measuring an interaction accuracy along with measuring the processing time. Accordingly, the interface adaptation apparatus measures the distance between the user's finger and the virtual interface again at step S310.

On the other hand, when the set object is the same object as the object set in the previous measurement at step S325, the interface adaptation apparatus determines whether a collision flag (collision event) has occurred during physics simulation at step S335. When the collision flag has not occurred, the interface adaptation apparatus measures the distance between the user's finger and the virtual interface again at step S310.

When the collision flag has occurred, the interface adaptation apparatus analyzes an interaction type at step S340. In some embodiments, the interface adaptation apparatus may analyze whether a specific manipulation (e.g., a manipulation such as selection, movement, rotation, or resize) on the virtual object or a specific interface type manipulation (e.g., a manipulation such as button, 2D panel, scroll bar, or dial) has been attempted or performed (e.g., succeeded), based on a collision result of the physics simulation. In some embodiments, the interface adaptation apparatus may continue to analyze the interaction type at step S340 until a collision cancellation flag (collision cancellation event) occurs during the physics simulation at step S345.

When the collision cancellation flag occurs as a result of the physical simulation at step S345, the interface adaptation apparatus determines whether the interaction is completed (i.e., a final manipulation is completed) at step S350. When the interaction is not completed at step S350, the interface adaptation apparatus measures the distance between the user's finger and the virtual interface again at step S310.

When the interaction is completed at step S350, the interface adaptation apparatus ends measuring the processing time at step S355, and stores data related to the interaction accuracy calculated based on the analysis of the interaction type at step S360. In some embodiments, the interface adaptation apparatus may store the total number of manipulation attempts and whether each manipulation is successful based on the interaction type, and the interaction information. In some embodiments, the interface adaptation apparatus may determine each interaction accuracy based on whether the corresponding interaction is successful and the total number of manipulation attempts of the interaction. In one embodiment, the interface adaptation apparatus may define each interaction accuracy as a value obtained by dividing the number of successful times of the corresponding interaction by the total number of manipulation attempts of the corresponding interaction. In some embodiments, the interface adaptation apparatus may store the interaction accuracy according to the interaction type and interaction information.

As such, the interface adaptation apparatus may continuously collect the interaction accuracy information through repeated operations. Accordingly, a plurality of interaction accuracies may be collected and stored in the database.

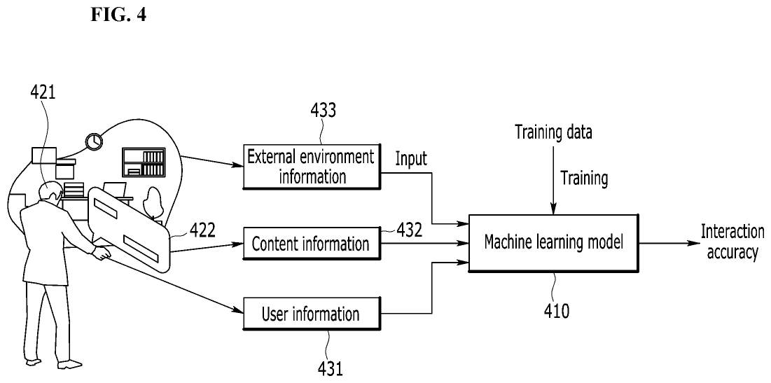

FIG. 4 is a diagram for explaining an example of individual characteristic analysis in a personalized interface adaptation apparatus according to an embodiment of the present invention.

In some embodiments, an interface adaptation apparatus may build a machine learning model 410 for predicting an interaction accuracy based on interaction information and interaction accuracies. The interface adaptation apparatus may predict the interaction accuracy of a current user for a specific interaction situation based on the machine learning model 410.

When the user 421 experiences AR content through a virtual interface 422, the interface adaptation apparatus may collect interaction information through an interaction information collector (e.g., 110 in FIG. 1). The interface adaptation apparatus may classify the interaction information collected by the interaction information collector 110 for each interaction measurement interval through an interaction accuracy measurer (e.g., 120 in FIG. 1). For example, since a processing time (i.e., a measurement interval) is also measured by the interaction accuracy measurer 120 when each interaction accuracy is collected, the interaction information collected in each measurement interval may be classified along with the interaction accuracy measured in the corresponding measurement interval.

The interface adaptation apparatus may group the interaction information collected in each measurement interval by group and set the grouped information as feature data. In some embodiments, the interface adaptation apparatus may set the user information 431 and the content information 432 collected in each measurement interval as the feature data, respectively. In one embodiment, the interface adaptation apparatus may additionally set the external environment information 433 collected in each measurement interval as the feature data. Further, the interface adaptation apparatus may define the interaction accuracy measured in each measurement interval as ground-truth. Accordingly, the interface adaptation apparatus may construct training data by tagging the feature data in each measurement interval with the interaction accuracy in the corresponding measurement interval as a label.

The interface adaptation apparatus may train the machine learning model 410 by using the training data as an input of the machine learning model 410. In some embodiments, the machine learning model 410 may be a model using a neural network. The neural network may be, for example, a neural network such as a convolutional neural network (CNN) or a recurrent neural network (RNN). In some embodiments, the machine learning model 410 may be trained by performing a task of predicting the interaction accuracy based on the feature data and backpropagating a loss between the prediction result and the interaction accuracy tagged in the corresponding feature data to update the neural network.

After training the machine learning model 410 in this way, the interface adaptation apparatus may predict the interaction accuracy in a current situation by inputting the interaction information 431, 432, 433 in the current situation to the machine learning model 410. Accordingly, the interface adaptation apparatus may predict the interaction accuracies in various situations and store the interaction accuracies together with the interaction information in the database. In some embodiments, the user information, the content information, the external environment information, and the interaction accuracy are mapped and stored in the database.

In some embodiments, the process of training the machine learning model may be performed in a non-real time period through a separate working thread in a program background.

In some embodiments, after the virtual interface is loaded, the machine learning model for the interaction accuracy may be repeatedly trained based on a state of an object changed by user manipulation or system selection. In some embodiments, when transformation of the object, color change of the object, or texture change of the object occurs, it may be determined that the state of the object has changed.

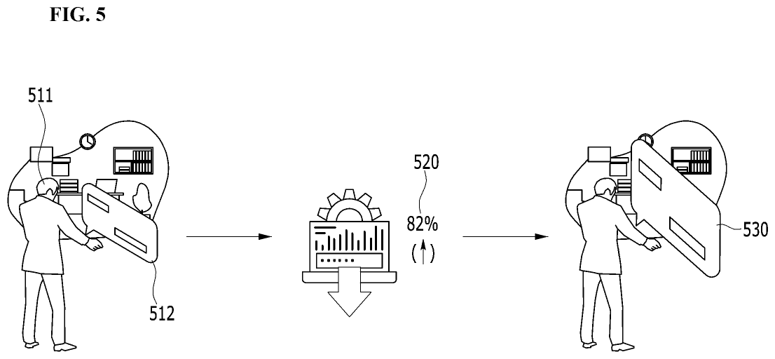

FIG. 5 is a diagram for explaining an example of interface recommendation in a personalized interface adaptation apparatus according to an embodiment.

Referring to FIG. 5, when a user 511 loads a virtual interface 512 to experience AR content, an interface adaptation apparatus collects context information. In some embodiments, the context information may include external environment information and user information. In some embodiments, the interface adaptation apparatus may also collect content information.

The interface adaptation apparatus may select the highest interaction accuracy 520 from among interaction accuracies mapped to the context information, and determine a state of the virtual interface, which is mapped to the highest interaction accuracy and the context information corresponding to the highest interaction accuracy. In some embodiments, in a case where interaction information (user information, content information, and external environment information) and interaction accuracy are mapped and stored in a database, a plurality of pieces of content information (states of the virtual interface) and a plurality of interaction accuracies may be mapped in specific context information (user information and external environment information). Therefore, the interface adaptation apparatus may select the highest interaction accuracy among the plurality of interaction accuracy mapped to the collected context information and retrieve (i.e., decide) the content information (i.e., the state of the virtual interface) mapped to the selected interaction accuracy. The interface adaptation apparatus may reload the decided state 530 of the virtual interface.

Therefore, the user can experience the AR content and maximize user experience by utilizing the interface state (configuration) having the best interaction accuracy.

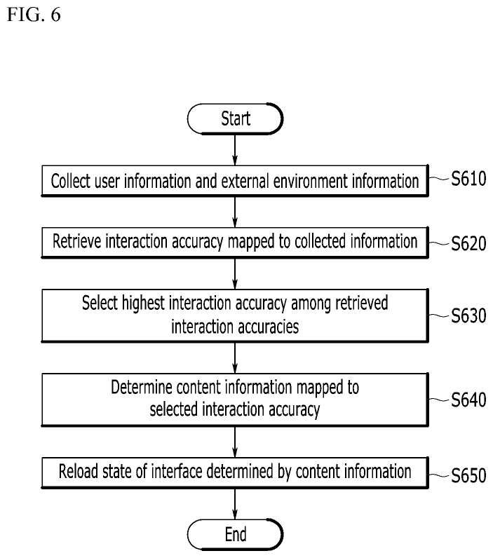

FIG. 6 is a flowchart showing an example of a method for adaptation of a personalized interface according to an embodiment.

Referring to FIG. 6, when a user experiences AR content by loading a virtual interface, an interface adaptation apparatus collects context information at step S610. In some embodiments, the context information may include user information and external environment information. The interface adaptation apparatus retrieves an interaction accuracy mapped to the collected context information at step S620. In some embodiments, the interface adaptation apparatus may retrieve the interaction accuracy mapped to the context information collected from mapping information between interaction information and interaction accuracies stored in the database.

The interface adaptation apparatus selects the highest interaction accuracy among the retrieved interaction accuracies at step S630, and determines content information mapped to the selected interaction accuracy at step S640. The interface adaptation apparatus reloads the virtual interface by reflecting a state of the virtual interface determined by the determined content information at step S650.

In some embodiments, the interface adaptation apparatus may measure an interaction accuracy based on the user information, the external environment information and the content information collected in step S610, and train the machine learning model for predicting the interaction accuracy again based on the collected user information, the external environment information and the content information, and the measured interaction accuracy,

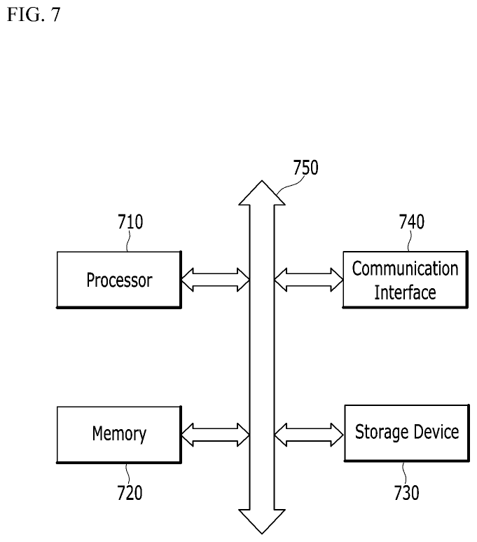

Next, an example computing device for implementing a personalized interface adaptation method or a personalized interface adaptation apparatus according to an embodiment of the present invention is described with reference to FIG. 7.

FIG. 7 is a diagram showing an example of a computing device according to an embodiment.

Referring to FIG. 7, a computing device includes a processor 710, a memory 720, a storage device 730, a communication interface 740, and a bus 750. The computing device may further include other general components.

The processor 710 controls an overall operation of each component of the computing device. The processor 710 may be implemented with at least one of various processing units such as a central processing unit (CPU), a microprocessor unit (MPU), a micro controller unit (MCU), and a graphic processing unit (GPU), or may be implemented with a parallel processing unit. Further, the processor 710 may perform operations on a program for executing a personalized interface adaptation method or functions of a personalized interface adaptation apparatus described above.

The memory 720 stores various data, instructions, and/or information. The memory 720 may load a computer program from the storage device 730 to execute the personalized interface adaptation method or the functions of the personalized interface adaptation apparatus. The storage device 730 may non-temporarily store the program. The storage device 730 may be implemented as a non-volatile memory.

The communication interface 740 supports wireless communication of the computing device.

The bus 750 provides a communication function between components of the computing device. The bus 750 may be implemented as various types of buses such as an address bus, a data bus, and a control bus.

The computer program may include instructions that cause the processor 710 to perform the personalized interface adaptation method or the functions of the personalized interface adaptation apparatus when loaded into the memory 720. That is, the processor 1110 may perform the personalized interface adaptation method or the functions of the personalized interface adaptation apparatus by executing the instructions.

The personalized interface adaptation method or the functions of the personalized interface adaptation apparatus may be implemented as a computer-readable program on a computer-readable medium. In some embodiments, the computer-readable medium may include a removable recording medium or a fixed recording medium. In some embodiments, the computer-readable program recorded on the computer-readable medium may be transmitted to another computing device via a network such as the Internet and installed in another computing device, so that the computer program can be executed by another computing device.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method for adaptation of an interface for extended reality by a computing device, the method comprising:
collecting first user information and first external environment information in response to a user loading a virtual interface to experience extended reality content;
selecting a highest interaction accuracy from among one or more interaction accuracies mapped to the first user information and the first external environment information;
determining first content information mapped to the highest interaction accuracy, and
reloading the virtual interface based on a state of the virtual interface that is determined based on the first content information.

2. The method of claim 1, wherein the selecting the highest interaction accuracy comprises:
retrieving the one or more interaction accuracies mapped to the first user information and the first external environment information from a database in which a plurality of interaction accuracies and a plurality of pieces of interaction information are respectively mapped; and
selecting the highest interaction accuracy from among the one or more interaction accuracies,
wherein in the plurality of pieces of interaction information, each interaction information includes second user information, second external environment information, and second content information.

3. The method of claim 2, wherein the determining the first content information comprises selecting the second content information mapped to the highest interaction accuracy from the database and determining the second content information as the first content information.

4. The method of claim 1, wherein the first content information comprises transformation information of the virtual interface, color information of the virtual interface, or texture information of the virtual interface

5. The method of claim 1, wherein the first user information comprises information related to movement of the user or information related to a gaze of the user.

6. The method of claim 1, wherein the first external environment information comprises information related to an external environment of the user.

7. The method of claim 1, wherein the one or more interaction accuracies comprise a previously-calculated interaction accuracy.

8. The method of claim 1, wherein the one or more interaction accuracies comprise an interaction accuracy predicted through a machine learning model

9. The method of claim 8, wherein the machine learning model is configured to be trained by using a previously-calculated interaction accuracy as a label, and user information, external environment information, and content information corresponding to the previously-calculated interaction data as training data.

10. A method for adaptation of an interface for extended reality by a computing device, the method comprising:
in response to a user attempting an interaction with a virtual interface, storing data related to an interaction accuracy of the interaction;
collecting a plurality of interaction accuracies by repeating storing the data related to the interaction accuracy; and
adapting the virtual interface for the user based on the plurality of interaction accuracies.

11. The method of claim 10, wherein the storing the data related to the interaction accuracy comprises:
after setting the virtual interface to an object attempting the interaction, analyzing a type of the interaction in response to a collision flag until a collision cancellation flag occurs; and
in response to completion of the interaction, storing data related to the interaction accuracy that is calculated based on analysis of the type of interaction.

12. The method of claim 11, wherein the storing the data related to the interaction accuracy further comprises setting the virtual interface to the object in response to a distance between a finger of the user and the virtual interface being less than or equal to a threshold.

13. The method of claim 11, wherein the storing the data related to the interaction accuracy further comprises:
starting measuring a processing time in response to the object being different from a previously-set object; and
ending measuring the processing time in response to the completion of the interaction.

14. The method of claim 11, wherein the storing the data related to the interaction accuracy further comprises:
determining whether the collision flag or the collision cancellation flag occurs during a physics simulation; and
analyzing the type of the interaction based on a collision result of the physics simulation.

15. The method of claim 11, wherein the storing the data related to the interaction accuracy further comprises calculating the interaction accuracy based on a total number of manipulation attempts and whether each manipulation is successful according to the analysis of the type of the interaction.

16. The method of claim 11, wherein the data related to the interaction accuracy comprises user information, external environment information, and content information when the user attempts the interaction with the virtual interface

17. The method of claim 16, further comprising training a machine learning model for predict an interaction accuracy by using the user information, the external environment information, and the content information as training data, and uses the interaction accuracy according to the user information, the external environment information and the content information as a label.

18. An interface adaptation apparatus comprising:
a memory configured to store one or more instructions; and
a processor configured to, by executing the one or more instructions,
collect user information and external environment information in response to a user loading a virtual interface to experience extended reality content;
select a highest interaction accuracy from among one or more interaction accuracies mapped to the collected user information and external environment information;
determine content information mapped to the highest interaction accuracy; and
reload the virtual interface based on a state of the virtual interface that is determined based on the determined content information.
